(19) United States
(12) Patent Application Publication
(10) Pub. No.: US 2026/0195768 A1
(43) Pub. Date: Jul. 9, 2026

(54) Market Value Booster (MVB): A Structured AI-Enhanced Framework for Business Ownership Transfers

(71) Applicant: Nikolai Safonov, Sarasota, FL (US)

(72) Inventor: Nikolai Safonov, Sarasota, FL (US)

(21) Appl. No.: 19/013,034

(22) Filed: Jan. 8, 2025

(51) Int. Cl. G06Q 30/018; G06Q 30/02; G06Q 40/06; G06Q 40/12

(52) U.S. Cl. CPC G06Q 30/018; G06Q 30/0278; G06Q 40/06; G06Q 40/12

(57) ABSTRACT

The present invention relates to a structured and AI-enhanced method for optimizing business ownership transfers, referred to as the Market Value Booster (MVB) process. This innovative process addresses inefficiencies in traditional business brokerage practices by prioritizing readiness and comprehensive documentation before listing a business for sale. The method includes assessing the business's operational, financial, and legal readiness; preparing and validating key documentation; generating accurate valuations using AI-driven models; facilitating transparent negotiations with potential buyers; and streamlining the buyer due diligence phase through an AI-powered document management system. The process further incorporates automated marketing material generation and AI training modules to enhance transaction efficiency and stakeholder confidence. By combining structured methodologies with advanced AI tools, the MVB process reduces transaction timelines, improves valuation accuracy, and increases the likelihood of successful business transfers, thereby delivering superior outcomes for sellers, buyers, and brokers.

### BACKGROUND OF THE INVENTION

### Field of Invention

The present invention relates to the field of business brokerage and transaction management, specifically to a structured process for enhancing the efficiency, accuracy, and reliability of business ownership transfers. More particularly, the invention employs artificial intelligence (AI)-driven tools and methodologies to optimize readiness assessments, financial analyses, valuation processes, and transaction documentation in order to improve outcomes for business sellers, buyers, and brokers.

### BRIEF SUMMARY OF THE INVENTION

The invention is directed toward a structured and innovative process, known as the Market Value Booster (MVB), which optimizes the transfer of business ownership by addressing inefficiencies inherent in traditional business brokerage methods. This process prioritizes readiness and comprehensive documentation before listing a business for sale, reducing delays, inaccuracies, and buyer withdrawals. Utilizing AI-driven tools, the MVB process streamlines information collection, analyzes financial data, automates valuation, and facilitates marketing and documentation management. These advancements ensure a smoother, faster, and more transparent transaction process, benefitting business owners, buyers, and brokers alike. The invention delivers significant improvements in valuation accuracy, transaction efficiency, and stakeholder confidence, ultimately fostering a healthier and more dynamic small business market.

### BRIEF DESCRIPTION OF THE FIGURES

FIG. 1: Discusses the due diligence readiness assessment phase, detailing steps 1.101 through 1.111.

FIG. 2: Covers the due diligence preparation phase, outlining steps 2.201 through 2.211.

FIG. 3: Focuses on the valuation and transaction closing phase, detailing steps 3.301 through 3.310.

### DETAILED DESCRIPTION

The present invention, referred to as the Market Value Booster (MVB) process, represents a significant advancement in the field of business brokerage and transaction management. This structured and innovative process addresses inefficiencies inherent in traditional methods of transferring business ownership by establishing a proactive framework that prioritizes readiness and comprehensive documentation. By integrating artificial intelligence (AI)-driven tools with established methodologies, the MVB process eliminates common pitfalls, such as inaccurate valuations, extended transaction timelines, and failed deals, thereby ensuring smoother, faster, and more transparent sales processes for business sellers, buyers, and brokers.

The MVB process is designed to be sequential and methodical, commencing with an assessment of a business's readiness for buyer due diligence. This foundational step identifies and resolves gaps in the business's financial records, operational practices, and legal compliance, thereby mitigating risks that could deter prospective buyers. Unlike traditional practices, which often bypass this critical preparatory phase, the MVB process ensures that businesses enter the market with the necessary documentation and operational stability to inspire buyer confidence. This readiness assessment benefits sellers by highlighting and addressing potential issues that could undermine negotiations, buyers by reducing perceived risks, and brokers by creating a clear roadmap that minimizes delays and disputes during the transaction.

Once readiness has been established, the process transitions to the preparation of documentation required for buyer due diligence. This stage involves the meticulous organization and validation of financial records, tax returns, contracts, and employment documentation to ensure consistency and eliminate potential liabilities.

Financial records are reconciled with bank statements, invoices, and tax filings, while contracts with clients and suppliers are reviewed for enforceability. Employment records are audited to verify proper classification of employees and subcontractors. By undertaking these actions proactively, the MVB process enables sellers to present a well-prepared business, reassures buyers of the business's stability and profitability, and streamlines the broker's workload during negotiations.

Following the preparation of documentation, the MVB process incorporates a valuation phase wherein the broker develops a professional opinion of the business's market value. Unlike conventional methods, which often conduct valuations without adequate preparation, the MVB process ensures that valuations are informed by verified and comprehensive data. AI-driven valuation models are employed to analyze financial performance metrics such as revenue trends, profitability, and cash flow, while also incorporating qualitative factors such as market trends and buyer trust. This hybrid approach, which combines AI analytics with broker expertise, produces valuations that are both accurate and credible. As a result, sellers achieve fair and justifiable pricing, buyers gain confidence in the valuation, and brokers are able to position the business as a high-value, low-risk opportunity.

The negotiation phase that follows is significantly enhanced by the thorough preparation undertaken in prior stages. With all documentation organized and verified, brokers can address buyer objections with confidence and transparency, resulting in smoother and more effective negotiations. The proactive nature of the MVB process reduces the likelihood of disputes, inspires buyer trust, and often results in higher sales prices. Sellers maintain control of negotiations supported by strong documentation, buyers experience transparency that encourages them to meet asking prices, and brokers benefit from expedited deal closures and fewer transaction-related conflicts.

The final stage of the MVB process encompasses the buyer due diligence phase and the closing of the transaction. By ensuring that all required documentation is prepared and accessible in advance, this stage proceeds with minimal complications, avoiding last-minute renegotiations or the risk of deal collapse. Sellers secure the agreed-upon price without unforeseen challenges, buyers gain confidence in their investment, and brokers are able to expedite the transaction, reducing the labor-intensive nature of this phase.

The MVB process integrates a suite of advanced technological features, including AI-guided information collection tools, AI-driven financial analysis algorithms, and automated marketing material generation systems. AI-guided tools streamline the collection of critical business data through structured web- or phone-based interviews, reducing the broker's workload while maintaining the business owner's motivation. Financial analysis algorithms validate key metrics such as revenue, profitability, and cash flow, ensuring data integrity and accuracy. Automated marketing tools leverage the verified dataset to create professional prospectuses and digital advertisements tailored to attract a broad audience of potential buyers.

Additionally, an AI-powered document management system facilitates the seamless organization and sharing of documentation during the due diligence phase, further reducing delays and ensuring smooth communication between sellers, brokers, and buyers. The process also incorporates microdata utilization, enabling brokers to train AI models to respond to standard buyer inquiries with precision and speed, thereby enhancing buyer confidence and expediting the negotiation process.

The MVB process distinguishes itself from existing methods by its structured and proactive approach. Traditional brokerage practices often prioritize expediency, valuing businesses before assessing readiness and addressing documentation gaps reactively during the transaction process. This reactive approach frequently results in inaccurate valuations, protracted sales cycles, and increased rates of transaction failure.

By contrast, the MVB process establishes a standardized sequence of preparatory actions that ensure businesses are market-ready before valuation and listing, thereby reducing risks, minimizing delays, and maximizing transaction outcomes for all stakeholders.

The widespread adoption of the MVB process is anticipated to have transformative effects on the business brokerage industry. It enhances the liquidity and marketability of small businesses, prevents closures due to ownership transitions, and fosters a healthier and more transparent market for business sales. On a broader scale, the MVB process supports economic stability by preserving jobs, promoting business continuity, and attracting investment.

Future advancements in AI technology are expected to further enhance the MVB process, enabling predictive analytics, automated co-brokerage collaborations, and adaptation to global markets with diverse regulatory requirements. By revolutionizing the business ownership transfer process, the MVB process delivers superior outcomes for sellers, buyers, and brokers, while contributing to the growth and resilience of the broader economy.

Below is a basic conceptual representation in Python to outline the automation of tasks such as AI-driven readiness assessments, financial analysis, and document management.

```
  class Market ValueBooster:
    def_{——}init_{——}(self, business_data):
      self.business_data = business_data
        self.documents = { }
        self.valuation = 0
        self.marketing_materials = [ ]
      def assess_readiness(self):
        “““Assess operational, financial, and legal readiness.”””
        readiness_report = { }
        for key, value in self.business_data.items( ):
          readiness_report[key] = “Ready” if value else “Needs Attention”
        return readiness_report
      def prepare_documentation(self, financials, contracts, employee_records):
        “““Prepare and validate documentation.”””
        self.documents[‘financials'] = self.validate_financials(financials)
        self.documents[‘contracts'] = self.validate_contracts(contracts)
        self.documents[‘employee_records'] =
self.validate_employee_records(employee_records)
      def validate_financials(self, financials):
        “““Validate financial documents.”””
        # Example: Reconcile accounting records with bank statements
        return {“status”: “Validated”, “details”: “All records match”}
      def validate_contracts(self, contracts):
        “““Ensure contracts are current and enforceable.”””
        return {“status”: “Validated”, “details”: “All contracts up-to-date”}
      def validate_employee_records(self, records):
        “““Audit employee classifications and compliance.”””
        return {“status”: “Validated”, “details”: “Employee records compliant”}
      def generate_valuation(self, revenue, profitability, market_trends):
        “““Generate valuation using AI analysis.”””
        # Simplified AI model for valuation
        self.valuation = (revenue * profitability * market_trends) / 100
        return self.valuation
      def generate_marketing_materials(self):
        “““Automate creation of marketing content.”””
        self.marketing_materials = [
          “Business Prospectus”,
          “Digital Advertisement”,
          “Sales Teaser”
        ]
        return self.marketing_materials
      def facilitate_negotiations(self, buyer_objections):
        “““Facilitate negotiations by addressing objections.”””
        responses ={objection: “Resolved with documentation” for objection in
buyer_objections}
        return responses
      def conduct_due_diligence(self):
        “““Streamline buyer due diligence with document sharing.”””
        return {“status”: “Due Diligence Completed”, “documents”: self.documents}
      def finalize_transaction(self):
        “““Complete the transaction.”””
        if self.valuation and self.documents:
          return {“status”: “Transaction Closed”, “valuation”: self.valuation}
        return {“status”: “Transaction Failed”, “reason”: “Incomplete Preparation”}
  # Example Usage
  business_data = {
    “financial_records”: True,
    “legal_compliance”: False,
    “operational_data”: True
  }
  mvb = MarketValueBooster(business_data)
  readiness = mvb.assess_readiness( )
  mvb.prepare_documentation(financials={ }, contracts={ }, employee_records={ })
  valuation = mvb.generate_valuation(revenue=500000, profitability=20,
market_trends=10)
  marketing = mvb.generate_marketing_materials( )
  negotiations = mvb.facilitate_negotiations(buyer_objections=[“Revenue
Accuracy”, “Contract Clarity”])
  due_diligence = mvb.conduct_due_diligence( )
  transaction = mvb.finalize_transaction( )
  # Outputs for demonstration
  print(“Readiness Assessment:”, readiness)
  print(“Valuation:”, valuation)
  print(“Marketing Materials:”, marketing)
  print(“Negotiation Responses:”, negotiations)
  print(“Due Diligence:”, due_diligence)
  print(“Transaction Status:”, transaction)
```

### DETAILED DESCRIPTION OF FIGURES

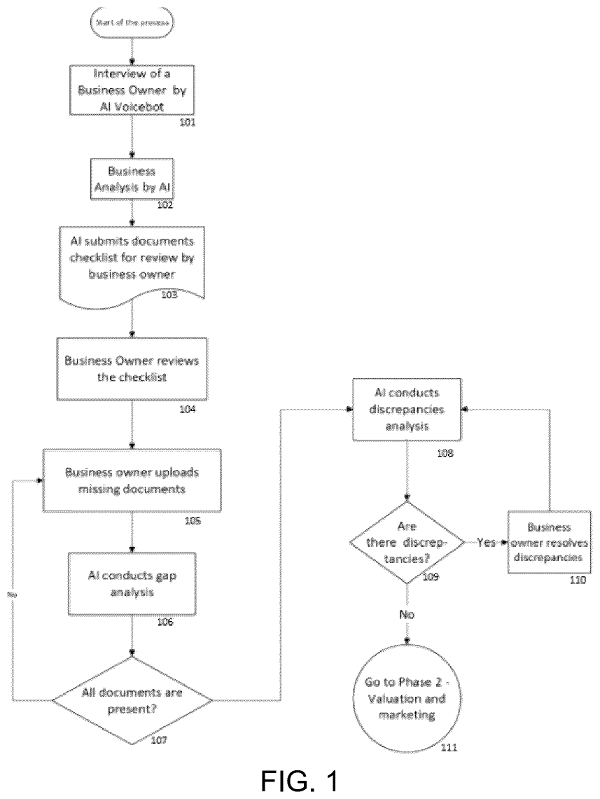

### FIG. 1: Due Diligence Readiness Assessment Phase

FIG. 1 encompasses steps 1.101 to 1.111, beginning with an AI voicebot interview of the business owner (1.101) to gather critical business information. The collected data is analyzed by AI in step 1.102 to evaluate readiness, followed by AI generating a document checklist in step 1.103 for the business owner's review (1.104). If documents are missing, the business owner uploads them in step 1.105. AI conducts a gap analysis in step 1.106 and determines in step 1.107 if all documents are present. If discrepancies are found, AI performs a detailed discrepancy analysis in step 1.108. Depending on the findings, the process loops to step 1.110 for the business owner to resolve discrepancies or progresses directly to step 1.111 to conclude the phase.

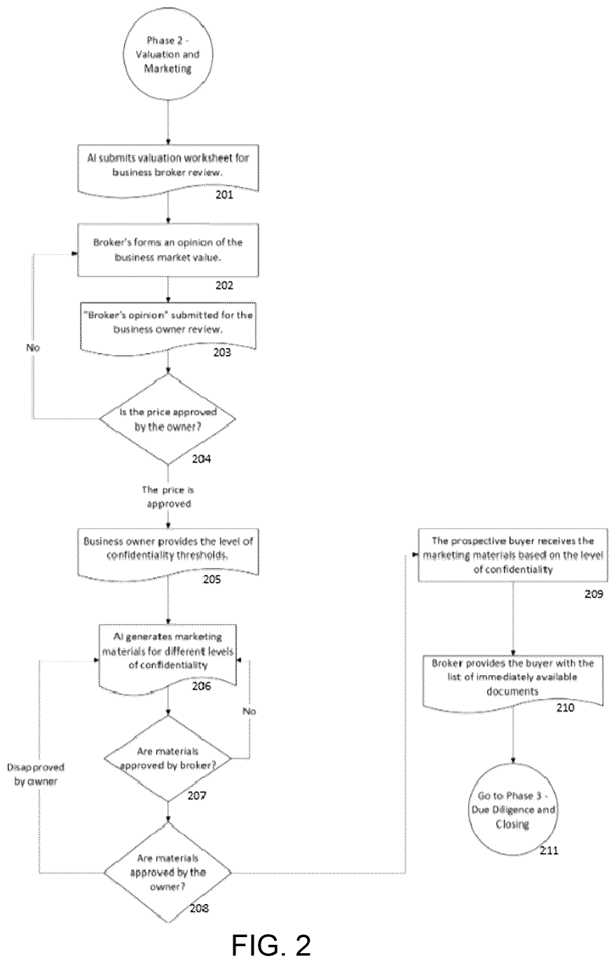

### FIG. 2: Due Diligence Preparation Phase

FIG. 2 outlines steps 2.201 to 2.211, starting with AI submitting a valuation worksheet to the broker for review in step 2.201. The broker forms a market value opinion in step 2.202, which is then submitted to the business owner in step 2.203 for approval. If the price is not approved, the process loops back to step 2.202; if approved, it proceeds to step 2.206 where AI generates marketing materials tailored to varying confidentiality thresholds. The materials are reviewed by the broker in step 2.207 and approved by the owner in step 2.208. Once finalized, the prospective buyer receives marketing materials based on confidentiality levels in step 2.209. The broker provides a list of available documents in step 2.210, concluding the phase at step 2.211.

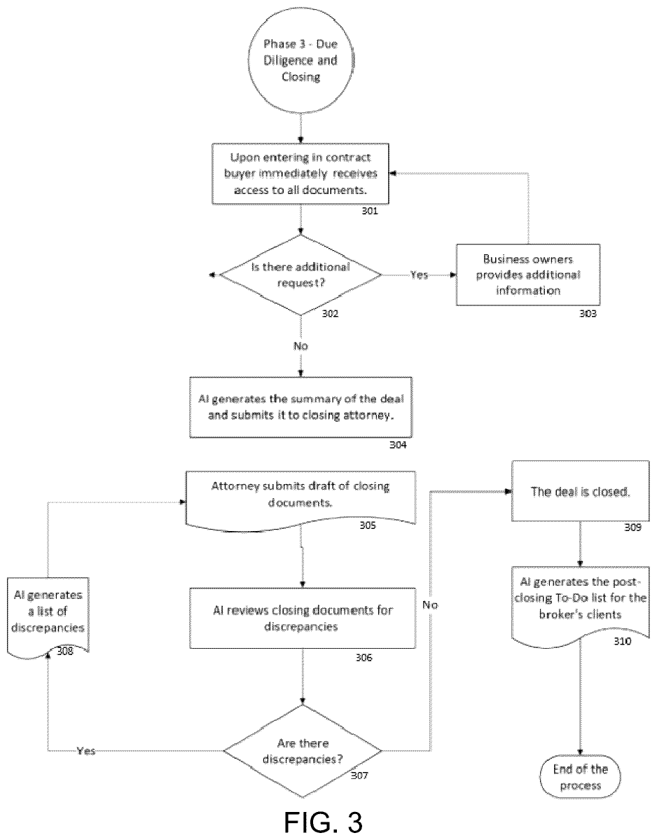

### FIG. 3: Valuation and Transaction Closing Phase

FIG. 3 includes steps 3.301 to 3.310, starting with the buyer gaining access to documents upon contract signing in step 3.301. If additional requests are made (3.302), the business owner provides supplementary information in step 3.303 before returning to step 3.301. Once resolved, AI generates a deal summary for the closing attorney in step 3.304. The attorney drafts closing documents in step 3.305, which AI reviews for discrepancies in step 3.306. If issues are found, AI generates a list in step 3.308, looping back to step 3.305 for resolution. Once resolved, the transaction is closed in step 3.309, and AI generates a post-closing to-do list for clients in step 3.310.

The Market Value Booster (MVB) process represents a significant advancement in business brokerage and transaction management. It addresses inefficiencies inherent in traditional methods of transferring business ownership by establishing a proactive framework that prioritizes readiness and comprehensive documentation. By integrating artificial intelligence (AI)-driven tools with established methodologies, the MVB process eliminates common pitfalls, such as inaccurate valuations, extended transaction timelines, and failed deals. This ensures smoother, faster, and more transparent sales processes for business sellers, buyers, and brokers.

### 1. Due Diligence Readiness Assessment Phase

This phase ensures the business is fully prepared for the buyer's due diligence. AI tools streamline the process, minimizing errors and improving efficiency, while allowing the business owner to work at their own pace.

### 1.1 Interview of a Business Owner by AI Voicebot

An AI Voicebot interviews the business owner to gather essential data about the business. By automating this initial step, the process avoids missed questions and ensures consistency across interviews.

### 1.2 Business Analysis by AI

AI analyzes the collected data to assess the business's current readiness for due diligence. For example, it flags areas where operational practices are incomplete or financial records need reconciliation.

### 1.3 Business Owner Reviews the Checklist

Based on the analysis, AI generates a checklist of required documents and actions. The owner reviews this, gaining clarity on what is needed to move forward.

### 1.4 Business Owner Uploads Missing Documents

The business owner uploads missing or incomplete documents as identified in the checklist. This step prevents potential roadblocks during later stages.

### 1.5 all Documents are Present

The system confirms that all required documents are accounted for, reducing the likelihood of missing items, such as gaps in bank statements or unsigned contracts. If gaps persist, the process loops back to Step 1.4.

### 2. Due Diligence Preparation Phase

This phase ensures that all documentation is error-free, complete, and ready for buyer scrutiny.

### 2.1 AI Conducts Discrepancy Analysis

AI cross-references documents to detect inconsistencies. For instance, it compares tax returns with financial statements to flag mismatches in reported revenue or profit.

### 2.2 AI Conducts Gap Analysis

AI identifies missing elements, such as omitted months in a sequence of bank statements or unsigned contracts, highlighting potential concerns for buyers.

### 2.3 Business Owner Resolves Discrepancies

The business owner addresses any issues flagged by the AI, such as providing the missing months of bank statements or correcting discrepancies in tax filings.

### 2.4 All Discrepancies Are Resolved

A final review ensures all discrepancies are addressed before moving to valuation. This step minimizes the risk of buyer objections later.

### 2.5 AI Submits Valuation Worksheet for Business Broker Review

AI compiles a valuation worksheet, providing the broker with comprehensive data to form a reliable market value opinion.

### 3. Valuation Phase

This phase leverages the data prepared in earlier steps to deliver an accurate and justifiable business valuation.

### 3.1 Broker Forms an Opinion of the Business Market Value

Using the AI-generated worksheet and their expertise, the broker analyzes the business's performance, market conditions, and risk profile to formulate a fair market value.

### 3.2 Broker's Opinion Submitted for Business Owner Review

The broker presents the valuation to the owner, explaining the rationale behind the price and inviting feedback.

### 3.3 is the Price Approved by the Owner?

If the owner agrees with the valuation, the process proceeds. If not, adjustments are made collaboratively.

### 4. Marketing Phase

This phase ensures the business is marketed effectively while maintaining confidentiality tailored to the seller's preferences.

### 4.1 Business Owner Provides Level of Confidentiality Thresholds

The business owner specifies how much information can be disclosed to potential buyers, ensuring their privacy and concerns are addressed.

### 4.2 AI Generates Marketing Materials for Different Levels of Confidentiality

AI creates tailored marketing materials, such as teasers or prospectuses, based on confidentiality thresholds. For instance, a teaser might only disclose high-level financials, while a prospectus includes detailed data.

### 4.3 Are Materials Approved by the Broker?

The broker reviews the materials for accuracy and compliance with confidentiality requirements, revising as needed.

### 4.4 Are Materials Approved by the Owner?

The owner provides final approval, ensuring alignment with their expectations.

### 5. Buyer Due Diligence and Closing Phase

The final phase ensures smooth due diligence and facilitates the deal closure with minimal delays.

### 5.1 The Prospective Buyer Receives Marketing Materials Based on

### Confidentiality

Buyers receive marketing materials tailored to their confidentiality agreements, ensuring trust and compliance.

5.2 Broker Provides the Buyer with the List of Immediately Available Documents

The broker informs the buyer about the set of, such as financial statements, which will be immediately available for buyer evaluation at the due diligence step.

5.3 Upon Entering into the Contract, Buyer Immediately Receives Access to all Documents

Once a purchase agreement is signed, the buyer gains full access to the earlier prepared documentation.

### 5.4 Is There an Additional Request?

Any additional buyer requests are addressed promptly by the business owner, minimizing delays.

### 5.5 AI Generates the Summary of the Deal and Submits It to Closing Attorney

AI compiles a comprehensive deal summary, reducing preparation time for closing attorneys.

### 5.6 Attorney Submits the Draft of Closing Documents

The attorney prepares and shares draft closing documents for review.

### 5.7 AI Reviews Closing Documents for Discrepancies

AI examines the drafts for inconsistencies, such as mismatched terms or misspelled names.

### 5.8 AI Generates a List of Discrepancies

If issues are found, AI generates a detailed list and sends it to the closing attorney for resolution (returning to step 5.6).

### 5.9 The Deal Is Closed

Once all discrepancies are resolved, the deal is finalized.

### 5.10 AI Generates the Post-Closing To-Do List for the Broker's Clients

A post-closing task list is provided to the seller and/or buyer, ensuring a smooth transition.

In general, machine learning algorithms are used to make a prediction or classification regarding inconsistencies and discrepancies in business sale transaction information. Based on some input data, which can be labeled or unlabeled, the algorithm will produce an estimate about a pattern in the data.

An error function evaluates the prediction of the model. If there are known examples, an error function can make a comparison to assess the accuracy of the model. A model optimization process then occurs. If the model can fit better to the data points in the training set, then weights are adjusted to reduce the discrepancy between the known example and the model estimate. The algorithm will repeat this “evaluate and optimize” process, updating weights autonomously until a threshold of accuracy has been met.

Supervised learning in particular uses a training set to teach models to yield the desired output. This training dataset includes inputs and correct outputs, which enables the model to learn over time. The algorithm measures its accuracy through the loss function, adjusting until the error has been sufficiently minimized. Thus, through the computer-implemented process described above, the present invention can improve its ability to predict and detect e.g., inconsistencies and discrepancies in business sale transaction information.

After training, the machine learning categorization engine processes the sensor data using pre-trained models trained on datasets of other business sale transactions and their inconsistencies and discrepancies. It comprises an application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze said business sale transaction information trained on historical datasets associating business sale transaction information with inconsistencies and discrepancies, wherein the AI/ML categorization engine makes a prediction regarding inconsistencies and discrepancies.

What is claimed is:

1. A method for optimizing business ownership transfers, comprising:
a. assessing the readiness of a business for buyer due diligence by identifying and resolving gaps in financial records, operational practices, and legal compliance;
b. preparing documentation necessary for buyer due diligence, including reconciling financial records, validating tax filings, ensuring enforceability of contracts, and auditing employment records;
c. generating a broker's opinion of the business's market value using a hybrid approach that incorporates AI-driven valuation models and professional expertise;
d. facilitating negotiations with potential buyers by presenting verified documentation and addressing objections transparently; and
e. completing the buyer due diligence phase and closing the transaction using a pre-organized and accessible documentation system to minimize delays and risks.

2. The method of claim 1, wherein the readiness assessment step is performed using AI-guided interview tools to collect critical business data and identify gaps in operational, financial, and legal compliance.

3. The method of claim 1, wherein the preparation of documentation includes:
a. reconciling accounting records with bank statements, invoices, and tax filings
b. validating contracts with clients and suppliers; and
c. auditing employment records to confirm compliance with applicable laws and regulations.

4. The method of claim 1, wherein the broker's opinion of market value is generated using AI-driven valuation models to analyze financial performance metrics, including revenue trends, profitability, and cash flow, in combination with qualitative factors such as market conditions and buyer trust.

5. The method of claim 1, further comprising the automated generation of marketing materials using AI tools to produce prospectuses, teasers, and advertisements tailored to various digital platforms.

6. The method of claim 1, wherein the negotiation phase includes presenting verified data and documentation to potential buyers to address objections and enhance buyer trust, thereby increasing the likelihood of a successful transaction.

7. The method of claim 1, wherein the buyer due diligence phase is facilitated by an AI-powered document management system that organizes and enables the sharing of necessary documentation among sellers, brokers, and buyers.

8. The method of claim 1, further comprising the use of microdata collected during the process to train AI models to respond to standard buyer inquiries, reducing broker workload and expediting the transaction process.

9. A system for optimizing business ownership transfers, comprising:
a. an AI-guided information collection tool configured to perform readiness assessments by gathering and organizing critical business data;
b. an AI-driven financial analysis module configured to validate and analyze financial records;
c. an AI-assisted valuation model configured to generate a broker's opinion of market value based on quantitative metrics and qualitative factors;
d. an automated marketing material generation tool configured to create tailored prospectuses and advertisements; and
e. an AI-powered document management system configured to organize and facilitate the sharing of documentation during buyer due diligence.

10. The system of claim 9, further comprising an AI training module configured to utilize microdata collected during the process to generate automated responses to buyer inquiries, thereby improving communication efficiency.

11. The method of claim 1, wherein the process reduces transaction time and increases buyer confidence by ensuring transparency, accuracy, and readiness at each stage of the business transfer.

12. The system of claim 9, wherein the automated marketing material generation tool enhances visibility and engagement with potential buyers by tailoring content for diverse digital platforms.

13. The method of claim 1, wherein the combination of AI-driven tools and structured processes improves the efficiency, reliability, and outcome of business ownership transfers for all stakeholders.

14. An application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze said business sale transaction information trained on historical datasets associating business sale transaction information with inconsistencies and discrepancies, wherein the AI/ML categorization engine makes a prediction regarding inconsistencies and discrepancies.
